(19) United States
(12) Patent Application Publication
(10) Pub. No.: US 2025/0384099 A1
(43) Pub. Date: Dec. 18, 2025

(54) INFORMATION PROCESSING APPARATUS

(71) Applicant: CANON KABUSHIKI KAISHA, Tokyo (JP)

(72) Inventor: MASAAKI SATO, Kanagawa (JP)

(21) Appl. No.: 19/223,168

(22) Filed: May 30, 2025

(30) Foreign Application Priority Data
Jun. 17, 2024 (JP) 2024-097519

(51) Int. Cl. G06F 16/955; H04N 1/00

(52) U.S. Cl. CPC G06F 16/9566; H04N 1/00222; H04N 1/00464

(57) ABSTRACT

To enable a Web browser not supported by a Web server to display a normal screen based on Web content sent from the Web server, an information processing apparatus includes: a unit that transmits a request including an access destination URL for downloading the Web content and a default UserAgent to a Web server designated by the access destination URL, in a case where the Web server designated by the access destination URL does not match a Web server designated by a registered URL; and a unit that transmits a request including the access destination URL and an alternative UserAgent associated with the registered URL to the Web server designated by the access destination URL, in a case where the Web server designated by the access destination URL matches the Web server designated by the registered URL.

### BACKGROUND

### Field of the Technology

The present disclosure relates to an information processing apparatus.

### Description of the Related Art

Some multifunction peripherals (also referred to as “MFPs”) including a plurality of functional units, such as a scanner unit and a printer unit, are equipped with a Web browser as one of the functional units. The Web browser sends a request to a network, such as the Internet, to download Web content from an access destination on the network. The request includes a URL indicating the access destination, and the request is routed to a Web server specified by a host name included in the URL. The request also includes a UserAgent. The UserAgent describes the name and version of the Web browser. The Web server generates Web content corresponding to the URL so as to be compatible with the Web browser whose name and version are described in the UserAgent, and sends the Web content to the Web browser that sent the request. Japanese Patent Laid-Open No. 2002-236641 discloses a technology in which a Web browser on a mobile phone describes information on the communication speed of the mobile phone in a UserAgent, and a Web server sends Web content corresponding to the communication speed of the mobile phone to the mobile phone, based on that information.

Many Web servers support many types of Web browsers installed on personal computers and smartphones, based on the assumption that a user uses the personal computer or smartphone to browse Web pages. Here, the type of Web browser corresponds to a combination of the name and version of the Web browser. On the other hand, some Web servers do not support some types of Web browsers. A Web browser installed in an MFP is not necessarily a Web browser generally installed in a personal computer or smartphone. Therefore, there are cases where a Web server that receives a request from the Web browser installed in the MFP does not support that Web browser. In such a case, a problem may arise that the Web browser cannot display a normal screen based on the downloaded Web content. This problem cannot be solved even by the technology disclosed in Japanese Patent Laid-Open No. 2002-236641.

### SUMMARY

The present disclosure has been made in consideration of the above points, and it is an object thereof to enable a Web browser that is not supported by a Web server to display a normal screen based on Web content sent from the Web server.

In a first aspect of the present disclosure, there is provided an information processing apparatus including: a first transmitting unit that transmits a request including an access destination URL for downloading Web content and a default UserAgent to a Web server designated by the access destination URL, in a case where the Web server designated by the access destination URL does not match a Web server designated by a registered URL; and a second transmitting unit that transmits a request including the access destination URL and an alternative UserAgent associated with the registered URL to the Web server designated by the access destination URL, in a case where the Web server designated by the access destination URL matches the Web server designated by the registered URL. In a second aspect of the present disclosure, there is provided an information processing apparatus including: a fourth transmitting unit that transmits a request including an access destination URL for downloading Web content and a default UserAgent to a Web server designated by the access destination URL, in a case where there is no extension app that holds an app-specific UserAgent to be included in a request to be transmitted to the Web server designated by the access destination URL; and a fifth transmitting unit that transmits a request including the access destination URL and the app-specific UserAgent to the Web server designated by the access destination URL, in a case where there is the extension app that holds the app-specific UserAgent.

Features of the present disclosure will become apparent from the following description of embodiments with reference to the attached drawings. The following description of embodiments are described by way of example.

### BRIEF DESCRIPTION OF THE DRAWINGS

FIG. 1 is a conceptual diagram showing a system including a multifunction peripheral, a Web server, and the Internet connecting them;

FIG. 2 is a functional block diagram showing a configuration of the multifunction peripheral;

FIG. 3 is a functional block diagram showing a configuration of a Web browser and an extension app according to a first embodiment;

FIG. 4 is a diagram showing an example of an alternative UserAgent management table;

FIG. 5 is a diagram showing an example of a default UserAgent management table;

FIG. 6 is a flowchart showing a request transmission method according to the first embodiment;

FIG. 7 is a functional block diagram showing a configuration of a Web browser and an extension app according to a second embodiment;

FIG. 8 is a diagram showing an example of an app-specific UserAgent management table;

FIG. 9 is a flowchart showing a request transmission method according to the second embodiment;

FIG. 10 is a flowchart showing a request transmission method according to a third embodiment;

FIG. 11 is a functional block diagram showing a configuration of a Web browser and an extension app according to the third embodiment;

FIG. 12 is a flowchart showing a UserAgent update method according to a fourth embodiment; and

FIG. 13 is a diagram showing an example of a screen used in the UserAgent update method according to the fourth embodiment.

### DESCRIPTION OF THE EMBODIMENTS

Hereinafter, embodiments will be described in detail with reference to the accompanying drawings. Note that the following embodiments do not limit the disclosure according to the claims. Although a plurality of features are described in the embodiments, not all of these features are necessarily essential to the disclosure, and the plurality of features may be combined in any manner. Furthermore, in the accompanying drawings, the same or similar configurations are denoted by the same reference numbers, and redundant description thereof may be omitted.

A multifunction peripheral according to the embodiment of the present disclosure will be described.

### First Embodiment

### 1. Overall Configuration

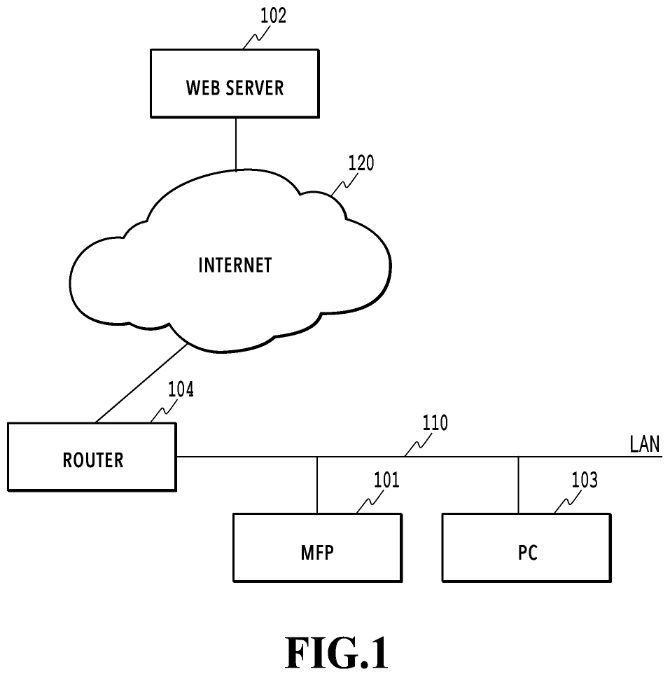

FIG. 1 is a conceptual diagram showing a system including a multifunction peripheral, a Web server, and the Internet connecting them.

A Web server 102 and an MFP 101 are communicably connected via the Internet 120, a router 104, and a LAN 110. The MFP 101 and an information processing apparatus 103 (also referred to as a “PC”) are communicably connected via the LAN 110. The Web server 102 may provide a cloud service in cooperation with other Web servers.

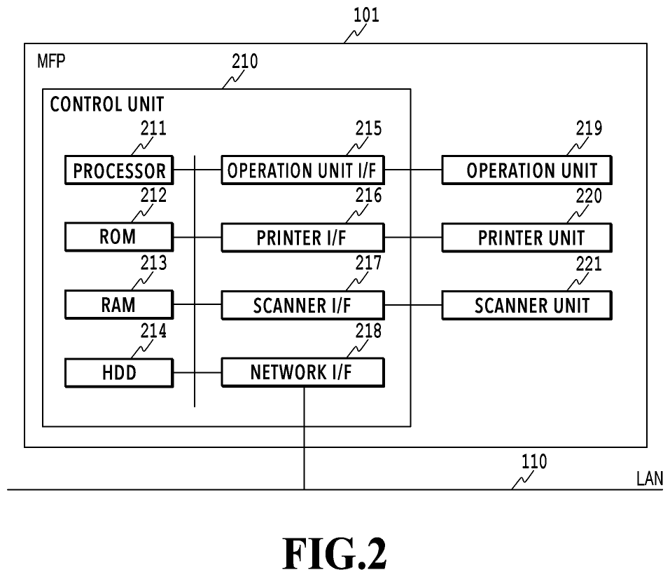

FIG. 2 is a functional block diagram showing a configuration of the MFP 101. A control unit 210 controls overall operations of the MFP 101. A processor 211, such as a CPU, included in the control unit 210 reads a control program stored in a ROM 212 to execute various control processing such as read control and transmission control. A RAM 213 is used as a temporary storage area, such as a main memory and a work area, for the processor 211. An HDD 214 stores image data and various programs. The various programs stored in the HDD 214 may include programs for performing the read control, transmission control, and the like. In this case, the processor 211 reads a control program stored in the HDD 214 to execute various control processing such as the read control and transmission control.

An operation unit I/F 215 connects an operation unit 219 to the control unit 210. The operation unit 219 is provided with a display unit (for example, a liquid crystal display unit with a touch panel function) with an input function, a keyboard, and the like.

A printer I/F 216 connects a printer unit 220 to the control unit 210. Image data to be printed by the printer unit 220 is transferred to the printer unit 220 from the processor 211, the RAM 213, the HDD 214, or other parts (not shown) of the control unit 210 via the printer I/F 216. The printer unit 220 prints images, characters, and the like on a printing medium such as paper based on the image data.

A scanner I/F 217 connects a scanner unit 221 to the control unit 210. The scanner unit 221 generates image data by reading an image of a document placed on a platen (not shown), for example, and supplies the image data to the processor 211, the RAM 213, the HDD 214, or other parts (not shown) of the control unit 210 via the scanner I/F 217.

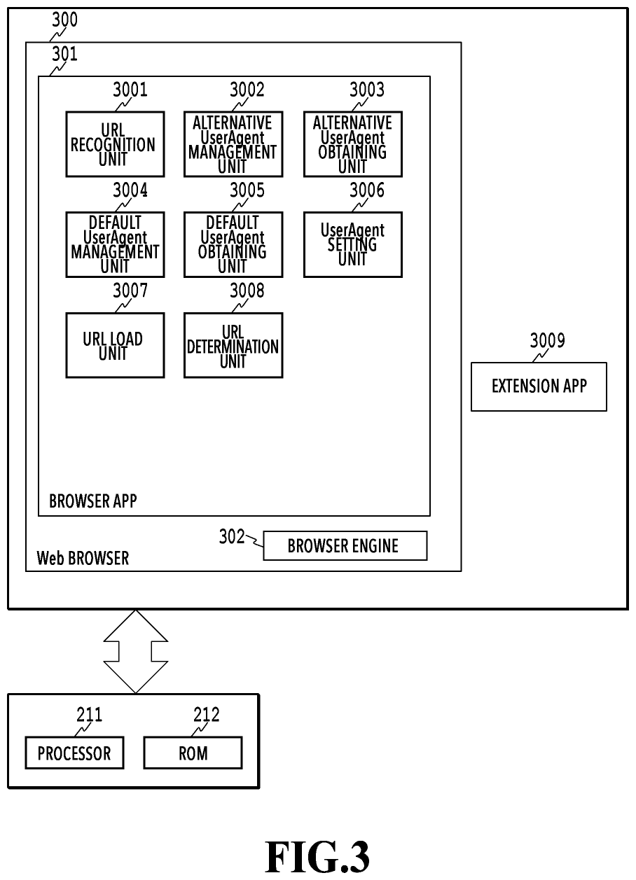

A network I/F 218 connects the control unit 210 to the LAN 110. The liquid crystal display unit included in the operation unit 219 can display a screen (also referred to as a “browser screen”) drawn by a Web browser 300 (see FIG. 3; also simply referred to as a “browser”). In a case where a user needs Web content provided by the Web server 102, the user can input an access destination URL for downloading the Web content into a URL input field of the browser screen. The network I/F 218 transmits a request for Web content to the LAN 110. The request includes a UserAgent in addition to the access destination URL.

The name and version of a browser engine 302 used by the Web browser 300 are generally described in the UserAgent. Here, the combination of the name and version of the Web browser identifies the type of the Web browser. The Web server 102 refers to the value of the UserAgent and transmits Web content compatible with the name and version of the browser engine 302 to the browser engine 302. However, this is only true in a case where the Web server 102 supports the browser engine 302 whose name and version are described in the UserAgent. Web content transmitted by the Web server 102 in a case where the Web server 102 does not support the browser whose name and version are described in the UserAgent is not necessarily compatible with that browser.

The URL includes a host name indicating the Web server 102. The request is transmitted from the LAN 110 to the Web server 102 indicated by the host name included in the URL via the router 104 and the Internet 120.

Upon receipt of the request, the Web server 102 returns a response that contains the Web content specified by the request to the Web browser 300 via the Internet 120, the router 104, the LAN 110, and the network I/F 218.

The Web content contained in the response is generally written using HTML, CSS, JavaScript (registered trademark), and the like. The Web browser 300 generates a display object such as an input field based on the Web content obtained from the Web server 102, and also performs processing (including processing related to the display object) based on JavaScript or the like included in the Web content. The generation of display objects based on Web content and such processing may be referred to as browser rendering processing. The Web browser 300 displays the display object obtained by the rendering processing on the browser screen.

### 2. Browser Configuration

FIG. 3 is a functional block diagram showing a configuration of the Web browser 300 and an extension app 3009 according to the first embodiment. The Web browser 300 includes a browser app 301 and the browser engine 302 as functional blocks. The browser app 301 includes a URL recognition unit 3001, an alternative UserAgent management unit 3002, an alternative UserAgent obtaining unit 3003, and a default UserAgent management unit 3004. The browser app 301 further includes a default UserAgent obtaining unit 3005, a UserAgent setting unit 3006, a URL load unit 3007, and a URL determination unit 3008. The extension app 3009 is, for example, a multifunctional embedded application platform (MEAP) app.

The extension app 3009 is an app to realize extension functions of the Web browser 300, but may be included in the Web browser 300.

As shown in FIG. 3, the Web browser 300 and the extension app 3009 function as the processor 211 reads and executes a program stored in the ROM 212. Alternatively, the Web browser 300 and the extension app 3009 function as the processor 211 reads and executes a program stored in the HDD 214.

Accordingly, the browser app 301 and the browser engine 302 included in the Web browser 300 also function as the processor 211 reads and executes a program stored in the ROM 212 or the HDD 214. The respective units 3001 to 3008 included in the browser app 301 also function as the processor 211 reads and executes programs stored in the ROM 212 or the HDD 214. The respective units included in the browser app 301 will be described in detail later.

A basic processing flow from recognition of an access destination URL by the Web browser 300 to downloading Web content specified by the URL will be described.

The browser app 301 recognizes an access destination URL inputted by the user in the URL input field provided on the browser screen.

The browser app 301 obtains a default UserAgent from the default UserAgent management unit 3004 that manages a UserAgent unique to the MFP 101 (also referred to as an “apparatus-specific UserAgent”) as the default UserAgent.

The browser app 301 sets the default UserAgent in the browser engine 302. The browser app 301 passes the access destination URL to the browser engine 302 and requests the browser engine 302 to load the URL. Here, loading the URL means downloading Web content specified by the URL from the Web server 102.

Upon receipt of the URL load request, the browser engine 302 transmits a request for the Web content to the LAN 110. The browser engine 302 includes the URL and the default UserAgent in the request.

A routing function of the network including the LAN 110, the router 104, and the Internet 120 allows the request transmitted to the LAN 110 to reach the Web server 102 specified by the host name included in the URL included in the request.

The extension app 3009 is an application to call up the Web browser 300. The extension app 3009 can hold a URL unique to the extension app 3009 (also referred to as an “app-specific URL”) and a UserAgent unique to the extension app 3009 (also referred to as an “app-specific UserAgent”). The extension app 3009 can start or call up the Web browser 300. The extension app 3009 can also hold a UserAgent compatible with the URL as an app-specific UserAgent. Upon starting or calling up the Web browser 300, the extension app 3009 passes the app-specific URL and the app-specific UserAgent to the Web browser 300. The browser engine 302 included in the Web browser 300 started or called up by the extension app 3009 transmits a request for Web content to the Web server 102 specified by the host name included in the app-specific URL. The browser engine 302 included in the Web browser 300 includes the app-specific URL and the app-specific UserAgent in this request. This makes it possible to save the user from the trouble of inputting the URL in the URL input field provided on the browser screen as the extension app 3009 starts or calls up the Web browser 300. This is particularly useful in a case where the URL accessed by the extension app is limited to a specific URL. This also makes it possible to transmit the app-specific UserAgent to the Web server 102 as the extension app 3009 starts or calls up the Web browser 300.

Note that a plurality of extension apps 3009 may be installed in the MFP 101. Each extension app 3009 may hold an app-specific URL and an app-specific UserAgent that are different from those of the other extension apps 3009. This makes it possible for different extension apps 3009 to transmit requests for different Web content to different Web servers 102, and to transmit different app-specific UserAgents.

### 3. Configuration of Browser App

The respective units included in the browser app 301 will be described in detail.

The URL recognition unit 3001 recognizes the URL inputted by the user in the URL input field provided on the browser screen. This URL is the access destination URL. Specifically, this URL indicates the location, on the network, of the Web content, for which a request is transmitted by the browser engine 302 to the Web server specified by the host name included in the URL. The URL may include the host name only, or may include the host name and a path name.

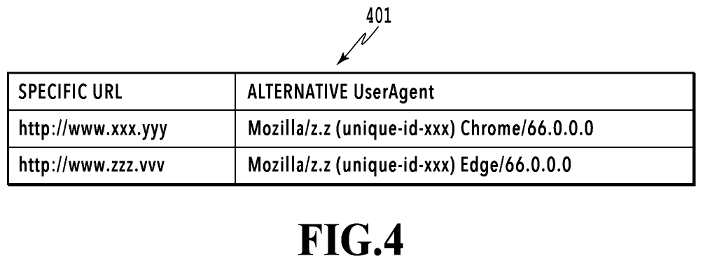

The alternative UserAgent management unit 3002 manages a plurality of pairs of specific URLs and alternative UserAgents, and also has an interface related thereto. FIG. 4 is a diagram showing an example of an alternative UserAgent management table (also referred to as a “correspondence table”) 401 used by the alternative UserAgent management unit 3002 to manage the plurality of pairs of specific URLs and alternative UserAgents. As shown in FIG. 4, in each record of the alternative UserAgent management table 401, a specific URL and an alternative UserAgent are stored in association with each other. Upon request for data from outside by specifying a record number and a field, the alternative UserAgent management unit 3002 returns the data stored in the specified field of the record having the specified record number. Therefore, upon request for data by specifying, for example, 1 as the record number and a specific URL as the field, the alternative UserAgent management unit 3002 returns “http://www.xxx.yyy”. In a case where the record number is 1 and the field is the alternative UserAgent, for example, the alternative UserAgent management unit 3002 returns “Mozilla/z.z (unique-id-xx) Chrome/66.0.0.0”. Here, “MOZILLA” and “Chrome” are registered trademarks.

The alternative UserAgent obtaining unit 3003 obtains a record number from the URL determination unit 3008 to be described later. The alternative UserAgent obtaining unit 3003 then obtains, via the alternative UserAgent management unit 3002, the alternative UserAgent stored in the record specified by that record number in the alternative UserAgent management table 401.

At least the name and version of any browser supported by the Web server specified by the host name included in the specific URL associated with the alternative UserAgent are described in the alternative UserAgent.

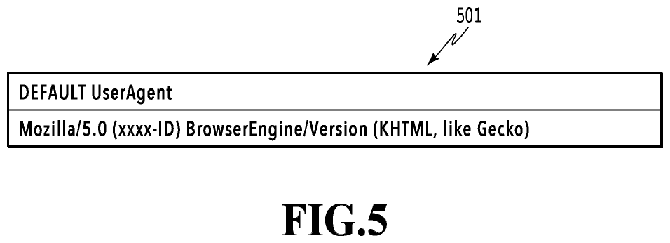

The default UserAgent management unit 3004 manages the default UserAgent and also has an interface related thereto. Here, as described above, the default UserAgent is the apparatus-specific UserAgent. FIG. 5 is a diagram showing an example of a default UserAgent management table 501 used by the default UserAgent management unit 3004 to manage the default UserAgent. As shown in FIG. 5, the default UserAgent management table 501 stores default UserAgents. In the example shown in FIG. 5, “xxx-ID” is an ID unique to the model of the multifunction peripheral. “BrowserEngine/Version (KHTML, like Gecko)” indicates the name and version of the browser engine 302.

Upon request for a default UserAgent from outside, the default UserAgent obtaining unit 3005 obtains the default UserAgent stored in the default UserAgent management table 501 and passes it as a return value to the request source. The default UserAgent obtaining unit 3005 obtains the default UserAgent stored in the default UserAgent management table 501 via the default UserAgent management unit 3004.

The UserAgent setting unit 3006 sets the UserAgent received from outside to the browser engine 302. Specifically, in a case where there is a specific URL that matches the destination URL, the UserAgent setting unit 3006 sets an alternative UserAgent associated with the specific URL to the browser engine 302. On the other hand, in a case where there is no specific URL that matches the destination URL, the UserAgent setting unit 3006 sets the default UserAgent to the browser engine 302. The UserAgent setting unit 3006 receives the result of the determination as to whether there is a specific URL that matches the destination URL from the URL determination unit 3008. Based on the determination result, the UserAgent setting unit 3006 then obtains an alternative UserAgent from the alternative UserAgent obtaining unit 3003, or obtains a default UserAgent from the default UserAgent obtaining unit 3005.

The URL load unit 3007 passes the access destination URL recognized by the URL recognition unit 3001 to the browser engine 302 and requests for URL loading. Upon receipt of the URL load request, the browser engine 302 transmits a request including the destination URL and the UserAgent set for itself by the UserAgent setting unit 3006 to the Web server 102.

The URL determination unit 3008 determines whether the access destination URL matches any of the specific URLs managed by the alternative UserAgent management unit 3002. In a case where the determination result is positive, the URL determination unit 3008 requests the alternative UserAgent obtaining unit 3003 to obtain an alternative UserAgent by passing the number of the record in which the specific URL matching the destination URL is stored. The URL determination unit 3008 also notifies the UserAgent setting unit 3006 of the determination result.

### 4. Browser Operation

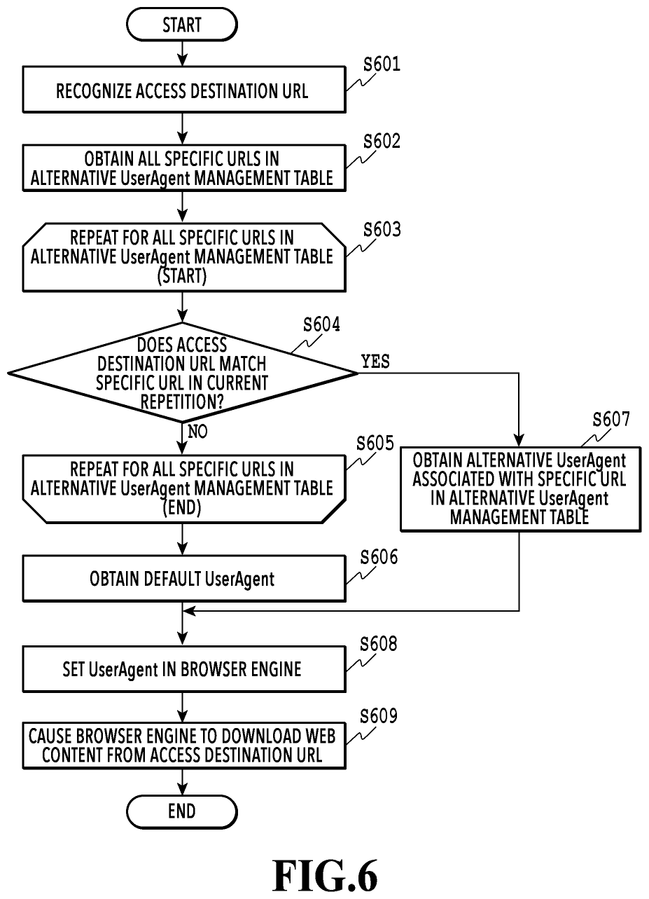

The user inputs the access destination URL into the URL input field of the browser screen drawn on the display unit by the Web browser 300. The processing from the recognition of the access destination URL to requesting the browser engine 302 to load the URL by the browser app 301 will be described with reference to a flowchart of FIG. 6.

Each step shown in the flowchart of FIG. 6 is executed by the processor 211 according to a control program stored in a memory such as the ROM 212. In this case, the processor 211 reads the control program from the memory, develops it in the RAM 213, and then executes each step according to the control program. The following description is given of a case where any of the functional blocks shown in FIG. 6 executes each step. However, as for any of the functional blocks, it is actually the processor 211 that executes each step to make the functional block function.

In S601, the URL recognition unit 3001 recognizes the access destination URL specified for the Web browser 300.

Next, in S602, the URL determination unit 3008 obtains all specific URLs stored in the alternative UserAgent management table 401 via the alternative UserAgent management unit 3002.

Next, S604 between S603 and S605 is repeated for all the specific URLs stored in the alternative UserAgent management table 401 at maximum. In relation to S602, S604 between S603 and S605 is repeated for all the specific URLs obtained in S602.

In S604, the URL determination unit 3008 determines whether the access destination URL matches the specific URL in the current repetition. This repetition is interrupted in a case where the URL determination unit 3008 determines in S604 that the access destination URL matches the specific URL in the current repetition, and the processing proceeds to S607.

As the repetition of S603 to S605 is completed for all the specific URLs stored in the alternative UserAgent management table 401, the processing proceeds to S606.

In S606, the default UserAgent obtaining unit 3005 obtains a default UserAgent from the default UserAgent management table 501 via the default UserAgent management unit 3004.

In S607, the alternative UserAgent obtaining unit 3003 obtains an alternative UserAgent associated with the specific URL determined to match the destination URL in S604. As described above, the alternative UserAgent associated with the specific URL determined to match the destination URL in S604 is managed by the alternative UserAgent management unit 3002 using the alternative UserAgent management table 401.

Therefore, the alternative UserAgent obtaining unit 3003 obtains an alternative UserAgent from the alternative UserAgent management unit 3002. To acquire the alternative UserAgent, the alternative UserAgent obtaining unit 3003 obtains the record number of a record in which the specific URL matching the destination URL is stored from the URL determination unit 3008, and passes it to the alternative UserAgent management unit 3002.

In either case where S606 or S607 is executed, the processing then proceeds to S608.

In S608, the UserAgent setting unit 3006 sets the UserAgent obtained in S606 or S607 in the browser engine 302. Specifically, in a case where the processing proceeds from S606 to S608, the UserAgent setting unit 3006 sets the default UserAgent obtained in S606 in the browser engine 302. On the other hand, in a case where the processing proceeds from S607 to S608, the UserAgent setting unit 3006 sets the alternative UserAgent obtained in S607 in the browser engine 302.

Therefore, in a case where the access destination URL matches any of the specific URLs stored in the alternative UserAgent management table 401, the alternative UserAgent corresponding to the matching specific URL is set in the browser engine 302. On the other hand, in a case where the access destination URL does not match any of the specific URLs stored in the alternative UserAgent management table 401, a default UserAgent is set in the browser engine 302.

Next, in S609, the URL load unit 3007 issues a request to the browser engine 302 to download Web content from the access destination URL. In response to this request, the browser engine 302 transmits a request to the Web server 102 to transmit the Web content. This request includes the access destination URL and the UserAgent set in the browser engine 302 in S608. Therefore, in a case where the access destination URL matches any of the specific URLs, the alternative UserAgent corresponding to the specific URL matching the destination URL is transmitted to the Web server 102 that is the destination of the request. On the other hand, in a case where the access destination URL does not match any of the specific URLs stored in the alternative UserAgent management unit 401, the default UserAgent is transmitted to the Web server 102 that is the destination of the request.

### 5. Example 1 of Browser Operation

A destination URL in Example 1 based on the first embodiment is “http://www.sss.ttt”, including a protocol. This is not managed as a specific URL in the alternative UserAgent management table 401.

In S601, the URL recognition unit 3001 recognizes the access destination URL “http://www.sss.ttt” specified for the Web browser 300.

Next, in S602, the URL determination unit 3008 obtains all specific URLs stored in the alternative UserAgent management table 401. In the example of FIG. 4, all the specific URLs are “http://www.xxx.yyy” and “http://www.zzz.vvv”.

Next, S604 between S603 and S605 is repeated for the two specific URLs stored in the alternative UserAgent management table 401. This is because the result of the determination in S604 is NO in the first and second repetitions.

Therefore, in S606, the default UserAgent obtaining unit 3005 obtains a default UserAgent from the default UserAgent management table 501 via the default UserAgent management unit 3004. Here, the default UserAgent is “Mozilla/5.0 (xxxx-ID) BrowserEngine/Version (KHTML, like Gecko)”. This includes a description that specifies the name and version of the browser engine 302 actually included in the Web browser 300.

In S608, the UserAgent setting unit 3006 sets the default UserAgent obtained in S606 in the browser engine 302.

Next, in S609, the URL load unit 3007 issues a request to the browser engine 302 to download Web content from the access destination URL “http://www.sss.ttt”. In response to this request, the browser engine 302 transmits a request to the Web server 102 to transmit the Web content. The request includes the access destination URL “http://www.sss.ttt” and the default UserAgent set in the browser engine 302 in S608.

A Web server 102 #A specified by the domain name “www.sss.ttt” included in the destination URL “http://www.sss.ttt” supports the browser engine 302 specified by the default UserAgent. Therefore, Web content transmitted by the Web server 102 #A to the Web browser 300 is compatible with the browser engine 302 specified by the default UserAgent. Therefore, a browser screen displayed by the Web browser 300 based on the Web content decoded by the browser engine 302 is normal.

### 6. Example 2 of Browser Operation

A destination URL in Example 2 based on the first embodiment is “http://www.zzz.vvv”, including a protocol. This is managed as a specific URL in the alternative UserAgent management table 401.

In S601, the URL recognition unit 3001 recognizes the access destination URL “http://www.zzz.vvv” specified for the Web browser 300.

Next, in S602, the URL determination unit 3008 obtains all specific URLs stored in the alternative UserAgent management table 401 via the alternative UserAgent management unit 3002. Here, all the specific URLs are “http://www.xxx.yyy” and “http://www.zzz.vvv”.

Next, S604 between S603 and S605 is generally repeated for a maximum of two specific URLs stored in the alternative UserAgent management table 401, but is interrupted at the second repetition in this embodiment.

In the first repetition, the result of the determination in S604 is NO.

In the second iteration, the result of the determination in S604 is YES.

Therefore, in S607, the alternative UserAgent obtaining unit 3003 obtains an alternative UserAgent “Mozilla/z.z (unique-id-xxx) Edge/66.0.0.0” (“EDGE” is a registered trademark). In other words, the alternative UserAgent obtaining unit 3003 obtains the alternative UserAgent from the alternative UserAgent management table 401 via the alternative UserAgent management unit 3002. This includes a description that specifies the name and version of a browser engine other than the browser engine 302 actually included in the Web browser 300.

In S608, the UserAgent setting unit 3006 sets the alternative UserAgent “Mozilla/z.z (unique-id-xxx) Edge/66.0.0.0” obtained in S607 in the browser engine 302.

Next, in S609, the URL load unit 3007 issues a request to the browser engine 302 to download Web content from the access destination URL “http://www.zzz.vvv”. In response to this request, the browser engine 302 transmits a request to the Web server 102 to transmit the Web content. The request includes the access destination URL “http://www.zzz.vvv” and the alternative UserAgent “Mozilla/z.z (unique-id-xxx) Edge/66.0.0.0” set in the browser engine 302 in S608.

A Web server 102 #B specified by the domain name included in the destination URL supports the browser engine specified by the alternative UserAgent. Here, the destination URL is “http://www.zzz.vvv”. The domain name included in this URL is “www.Zzz.vvv”. The alternative UserAgent is “Mozilla/z.z (unique-id-xxx) Edge/66.0.0.0”. Therefore, Web content transmitted to the Web browser 300 by the Web server 102 #B is compatible with the browser engine specified by the alternative UserAgent. Therefore, in a case where the browser engine 302 included in the Web browser 300 is the browser engine specified by the alternative UserAgent, such a browser engine can properly decode the Web content. Then, the Web browser 300 can display a normal browser screen.

However, the browser engine 302 included in the Web browser 300 is actually not the browser engine specified by the alternative UserAgent. Therefore, there is no guarantee that the browser engine 302 included in the Web browser 300 can properly decode the Web content generated to be compatible with the browser engine specified by the alternative UserAgent.

However, even in a case where the Web content of the URL “http://www.zzz.vvv” is created to be compatible with the browser engine specified by the alternative UserAgent, the following can be confirmed in advance. Specifically, it can be confirmed in advance that a browser screen displayed by the Web browser 300 based on such Web content decoded by the browser engine 302 is normal. From another perspective, a pair of the designated URL (also referred to as a “registered URL”) and the alternative UserAgent, for which this has been confirmed, is registered in the alternative UserAgent table 401.

Therefore, the browser screen displayed by the Web browser 300 based on the Web content decoded by the browser engine 302 is normal.

It can be said that the alternative UserAgent contains information about the type of Web browser (combination of name and version) that satisfies Conditions 1 to 3 below.

Condition 1: The type of Web browser is other than that of the Web browser used to display a screen based on the Web content.

Condition 2: The type of any of the Web browsers supported by the Web server designated by the registered URL.

Condition 3: A normal screen can be displayed by the Web browser used to display a screen based on the Web content generated by the Web server indicated by the registered URL so as to correspond to that type of Web browser.

### 7. Comparative Example

In a case where S603, S604, S605, and S607 are deleted, Example 2 is changed as follows.

A destination URL in Comparative Example is “http://www.zzz.vvv”, including a protocol, as in Example 2. This is managed as a specific URL in the alternative UserAgent management table 401.

In S601, the URL recognition unit 3001 recognizes the access destination URL “http://www.zzz.vvv” specified for the Web browser 300.

Next, in S602, the URL determination unit 3008 obtains all specific URLs stored in the alternative UserAgent management table 401 via the alternative UserAgent management unit 3002. Here, all the specific URLs are “http://www.xxx.yyy” and “http://www.zzz.vvv”.

In S606, the default UserAgent obtaining unit 3005 obtains a default UserAgent from the default UserAgent management table 501 via the default UserAgent management unit 3004. This includes a description that specifies the name and version of the browser engine 302 actually included in the Web browser 300.

In S608, the UserAgent setting unit 3006 sets the default UserAgent obtained in S606 in the browser engine 302.

Next, in S609, the URL load unit 3007 issues a request to the browser engine 302 to download Web content from the access destination URL “http://www.zzz.vvv”. In response to this request, the browser engine 302 transmits a request to the Web server 102 to transmit the Web content. The request includes the access destination URL “http://www.zzz.vvv” and the default UserAgent set in the browser engine 302 in S608.

The Web server 102 #B specified by the domain name “www.zzz.vvv” included in the URL “http://www.zzz.vvv” does not support the browser engine 302 specified by the default UserAgent.

Therefore, it is highly likely that the Web content transmitted to the Web browser 300 by the Web server 102 #B is not compatible with the browser engine 302 specified by the default UserAgent. Therefore, it is highly likely that a browser screen displayed by the Web browser 300 based on the Web content decoded by the browser engine 302 is not normal.

An abnormal browser screen is, for example, a screen in which a display object that does not allow data input is placed in a position where a text box for data input should be placed. In a case where such a screen is, for example, a login screen for using a cloud service from the MFP 101, the user cannot input his/her ID and password required for login using the input function of the operation unit 219.

In a case where the host names included in the URLs are the same even with different paths included in the URLs, it may be possible to display a normal screen using the browser engine 302 for all Web contents generated by the Web server so as to be compatible with the alternative UserAgent. In such a case, only the host names of the destination URL and of the specific URL may be compared, regardless of the presence or absence of a path or a difference between paths.

Even in a case where the same Web server generates Web content to be compatible with the alternative UserAgent, the following measures may be taken in a case where there are paths in which a normal screen can be and cannot be displayed using the browser engine 302. Specifically, the alternative UserAgent table 401 may be generated, including the path specification. Then, the combination of the host name and path of the destination URL may be compared with the combination of the host name and path of the specific URL.

### Second Embodiment

### 1. Overview

A second embodiment makes it possible to set the app-specific UserAgent held by the extension app.

### 2. Configuration of Browser and Browser App

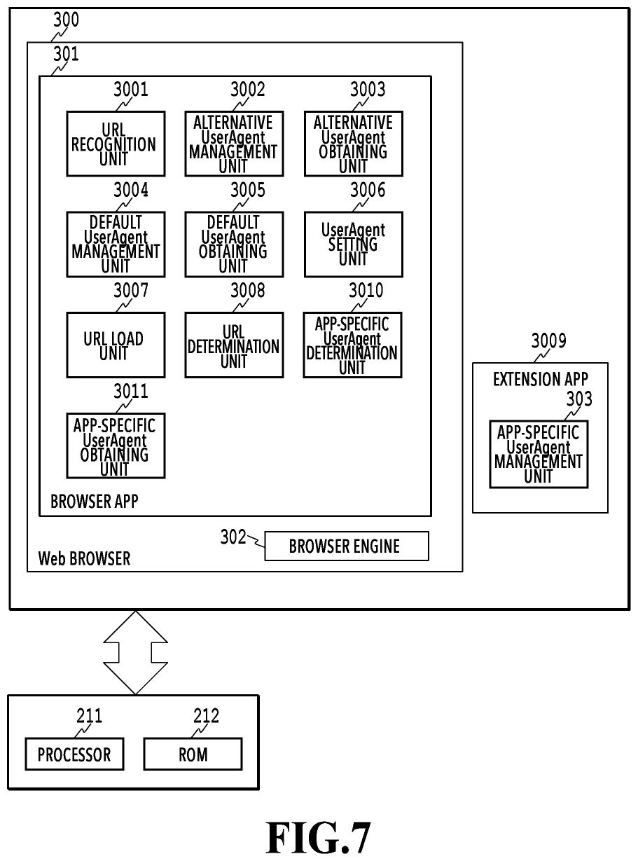

FIG. 7 is a functional block diagram showing a configuration of a Web browser 300 and an extension app 3009 according to the second embodiment.

Comparing FIGS. 3 and 7, only differences in configuration between the first and second embodiments will be described.

Compared to the browser app 301 of the first embodiment, a browser app 301 of the second embodiment additionally includes an app-specific UserAgent determination unit 3010 and an app-specific UserAgent obtaining unit 3011. The extension app 3009 also additionally includes an app-specific UserAgent management unit 303.

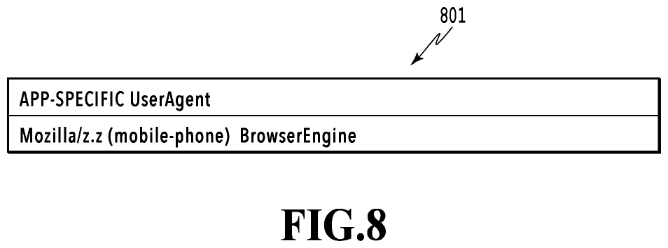

The app-specific UserAgent management unit 303 manages an app-specific UserAgent and has an interface associated therewith. Here, the app-specific UserAgent is a UserAgent that is specific to the extension app 3009. FIG. 8 is a diagram showing an example of an app-specific UserAgent management table 801 used by the app-specific UserAgent management unit 303 to manage the app-specific UserAgent. As shown in FIG. 8, the app-specific UserAgent management table 801 stores the app-specific UserAgent. In the example shown in FIG. 8, “Mozilla/z.z (mobile-phone) BrowserEngine” indicates the name and version of the browser engine 302.

The app-specific UserAgent determination unit 3010 determines whether the extension app 3009 holds the app-specific UserAgent. Specifically, the extension app 3009 has the app-specific UserAgent management unit 303, and the app-specific UserAgent management unit 303 determines whether the app-specific UserAgent is held, using the app-specific UserAgent management table 801.

Upon request for the app-specific UserAgent from outside, the app-specific UserAgent obtaining unit 3011 performs the following. That is, the app-specific UserAgent obtaining unit 3011 obtains the app-specific UserAgent stored in the app-specific UserAgent management table 801 via the app-specific UserAgent management unit 303, and passes it as a return value to the request source.

### 3. Browser Operation

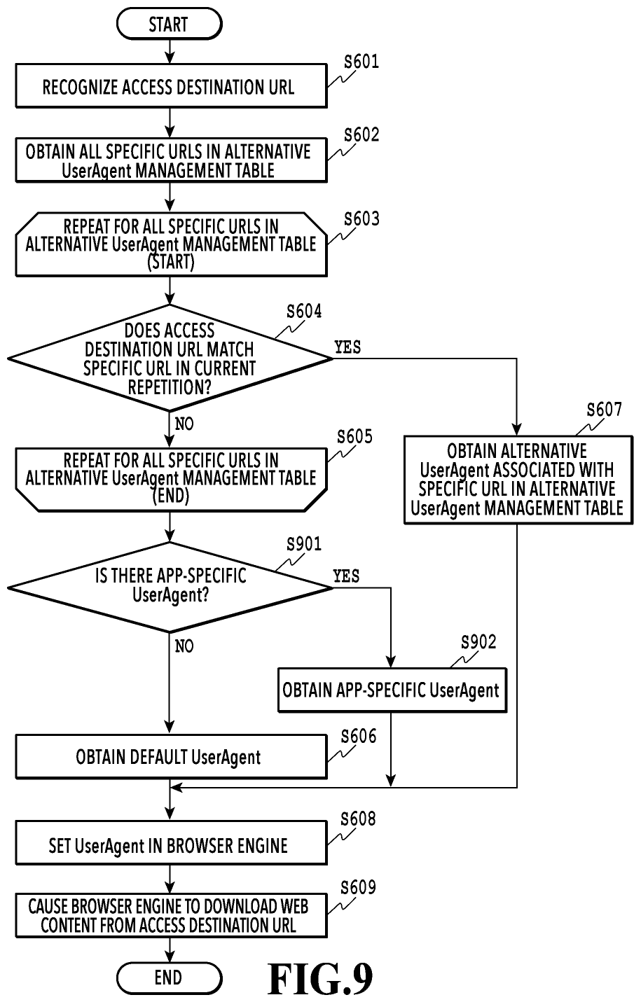

FIG. 9 is a flowchart showing a request transmission method according to the second embodiment.

Comparing FIGS. 6 and 9, only differences in request transmission method between the first and second embodiments will be described.

Compared to the request transmission method of the first embodiment, S901 and S902 are added to the request transmission method of the second embodiment.

In a case where there is no specific URL that matches the access destination URL, the repetition of S603 to S605 is completed. In the first embodiment, the processing proceeds to S606 after completion of the repetition. In the second embodiment, on the other hand, determination in S901 is executed before proceeding to S606.

In S901, the app-specific UserAgent determination unit 3010 uses the app-specific UserAgent management table 801 to determine whether the extension app 3009 holds the app-specific UserAgent. In other words, the app-specific UserAgent determination unit 3010 uses the app-specific UserAgent management table 801 to determine whether there is the extension app 3009 that holds the app-specific UserAgent.

In a case where the extension app 3009 holds the app-specific UserAgent, the app-specific UserAgent obtaining unit 3011 obtains the app-specific UserAgent in S902. That is, the app-specific UserAgent obtaining unit 3011 obtains the app-specific UserAgent held in the app-specific UserAgent management table 801 via the app-specific UserAgent management unit 303.

In S608, the UserAgent setting unit 3006 sets the UserAgent obtained in S606, S607 or S902 in the browser engine 302. Specifically, in a case where the processing proceeds from S606 to S608, the UserAgent setting unit 3006 sets the default UserAgent obtained in S606 in the browser engine 302. In a case where the processing proceeds from S607 to S608, the UserAgent setting unit 3006 sets the alternative UserAgent obtained in S607 in the browser engine 302. In a case where the processing proceeds from S902 to S608, the UserAgent setting unit 3006 sets the app-specific UserAgent obtained in S902 in the browser engine 302.

Therefore, in a case where the access destination URL matches any of the specific URLs stored in the alternative UserAgent management table 401, the alternative UserAgent corresponding to the matching specific URL is set in the browser engine 302. On the other hand, in a case where the access destination URL does not match any of the specific URLs stored in the table 401 and the extension app has the app-specific UserAgent, the app-specific UserAgent is set in the browser engine 302. In a case where the access destination URL does not match any of the specific URLs stored in the table 401 and the extension app does not have the app-specific UserAgent, the default UserAgent is set in the browser engine 302.

Next, in S609, the URL load unit 3007 issues a request to the browser engine 302 to download Web content from the access destination URL. In response to this request, the browser engine 302 transmits a request to the Web server 102 to transmit the Web content. The request includes the access destination URL and the UserAgent set in the browser engine 302 in S608. Therefore, in a case where the access destination URL matches any of the specific URLs, the alternative UserAgent corresponding to the specific URL corresponding to the destination URL is transmitted to the Web server 102, which is the destination of the request. In a case where the access destination URL does not match any of the specific URLs stored in the alternative UserAgent management unit 401 and the extension app has an app-specific UserAgent, the app-specific UserAgent is transmitted to the Web server 102. In a case where the access destination URL does not match any of the specific URLs stored in the alternative UserAgent management table 401 and the extension app does not have the app-specific UserAgent, the default UserAgent is transmitted to the Web server 102.

There is also a Web server 102 that cannot transmit Web content compatible with the browser engine specified by the default UserAgent, but can transmit Web content compatible with the browser engine specified by the extension app UserAgent. According to the second embodiment, in a case where the extension app 3009 has an app-specific UserAgent, the app-specific UserAgent is basically transmitted to the Web server 102. Therefore, the second embodiment can be applied to such a Web server 102.

Even in a case where the browser engine 302 is specified by the extension app 3009 to use the app-specific UserAgent, a situation may occur in which a specific URL is inputted by the user. According to the second embodiment, even in a case where such a situation occurs, the browser engine 302 can display a normal screen.

For example, it can be assumed that a screen based on Web content is displayed in a Web browser provided in the extension app 3009 while using the respective units (3001 to 3011) included in the browser app 301 of the MFP 101. In this case, the Web server can transmit Web content compatible with the Web browser provided in the extension app 3009. The extension app may be installed in a mobile terminal connected to the MFP 101 via a wireless LAN or the like.

Note that the MFP 101 may be provided with a plurality of extension apps 3009. Each extension app 3009 may have an app-specific URL and an app-specific UserAgent that are different from those of the other extension apps 3009. Therefore, different extension apps 3009 can transmit different Web content requests to different Web servers 102, and can also transmit different app-specific UserAgents.

### 4. Example 3 of Browser Operation

A destination URL in Example 3 based on the second embodiment is “http://www.qqq.rrr”, including a protocol. This is not managed as a specific URL in the alternative UserAgent management table 401.

In S601, the URL recognition unit 3001 recognizes the access destination URL “http://www.qqq.rrr” specified for the Web browser 300.

Next, in S602, the URL determination unit 3008 obtains all specific URLs stored in the alternative UserAgent management table 401 via the alternative UserAgent management unit 3002. Here, all the specific URLs are “http://www.xxx.yyy” and “http://www.zzz.vvv”.

Next, S604 between S603 and S605 is repeated for the two specific URLs stored in the alternative UserAgent management table 401. This is because the result of the determination in S604 is NO in the first and second repetitions.

Therefore, in S901, the app-specific UserAgent determination unit 3010 determines whether the extension app has an app-specific UserAgent. It is assumed in Example 3 that the extension app has the app-specific UserAgent.

In S902, the app-specific UserAgent obtaining unit 3011 obtains the app-specific UserAgent from the app-specific UserAgent management table 801 via the app-specific UserAgent management unit 303. Here, the app-specific UserAgent is “Mozilla/z.z (mobile-phone) BrowserEngine”. This includes a description that specifies the name and version of the browser engine included in the browser for a mobile terminal as the extension app 3009.

In S608, the UserAgent setting unit 3006 sets the app-specific UserAgent “Mozilla/z.z (mobile-phone) BrowserEngine” obtained in S902 in the browser engine 302.

Next, in S609, the URL load unit 3007 issues a request to the browser engine 302 to download Web content from the access destination URL “http://www.qqq.rrr”. In response to this request, the browser engine 302 transmits a request to the Web server 102 to transmit the Web content. The request includes the access destination URL and the app-specific UserAgent set in the browser engine 302 in S608. The access destination URL here is “http://www.qqq.rrr”, and the app-specific UserAgent set in the browser engine 302 is “Mozilla/z.z (mobile-phone) BrowserEngine”.

A Web server 102 #C specified by the domain name included in the destination URL supports the browser engine of the Web browser provided in the extension app 3009 specified by the app-specific UserAgent. Therefore, Web content transmitted by the Web server 102 #C is compatible with the browser engine of the Web browser included in the extension app 3009 specified by the app-specific UserAgent. Therefore, a browser screen displayed by the browser engine of the Web browser included in the extension app 3009 based on the Web content decoded by the browser engine is normal.

### Third Embodiment

### 1. Overview

In a third embodiment, the priority of replacing the default UserAgent with the alternative UserAgent or replacing the default UserAgent with the app-specific UserAgent is reversed from that of the second embodiment.

It may be possible to assume that the Web browser 300 or the browser included in the extension app can display a normal screen based on the Web content generated by the Web server so as to be compatible with the browser specified by the app-specific UserAgent. In particular, such a situation may be assumed even in a case where the access destination URL is a specific URL registered in the alternative UserAgent management table 401. In such a case, an app-specific UserAgent may be used as the UserAgent regardless of the access destination URL. The third embodiment is applicable to such a case.

### 2. Configuration of Browser and Browser App

The configuration of the browser and the browser app according to the third embodiment is basically the same as the configuration of the browser and the browser app according to the second embodiment.

### 3. Browser Operation

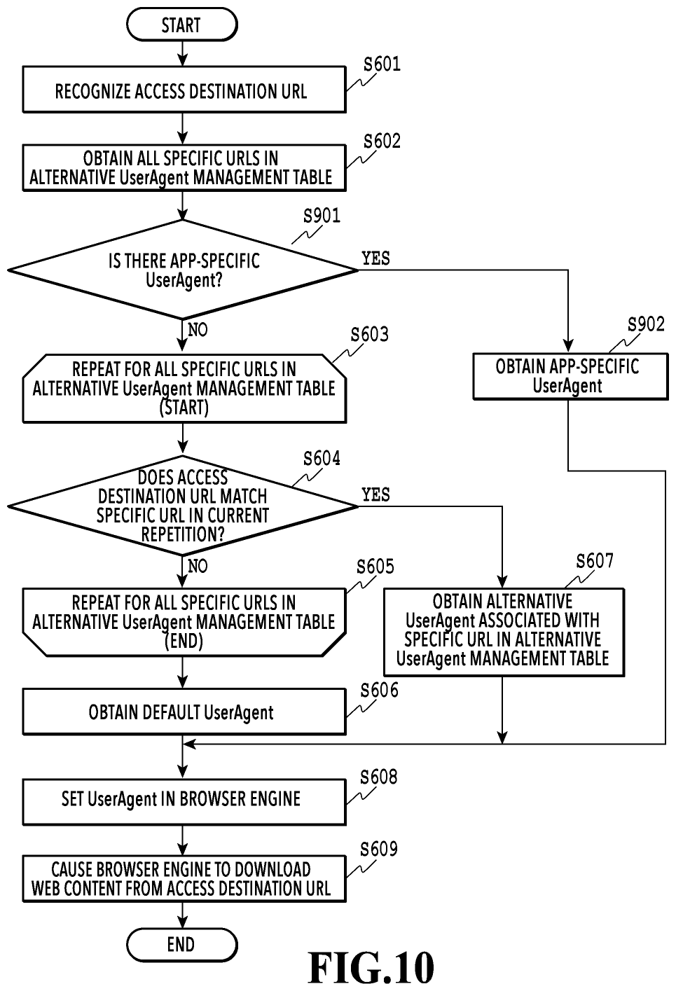

FIG. 10 is a flowchart showing a request transmission method according to the third embodiment. In the request transmission method according to the third embodiment, the order of steps included in the request transmission method according to the second embodiment is changed. Specifically, S901 is moved from immediately after S605 to immediately after S602.

### Fourth Embodiment

### 1. Overview

A fourth embodiment makes it possible for the user to edit the alternative UserAgent management table 401.

### 2. Configuration of Browser and Browser App

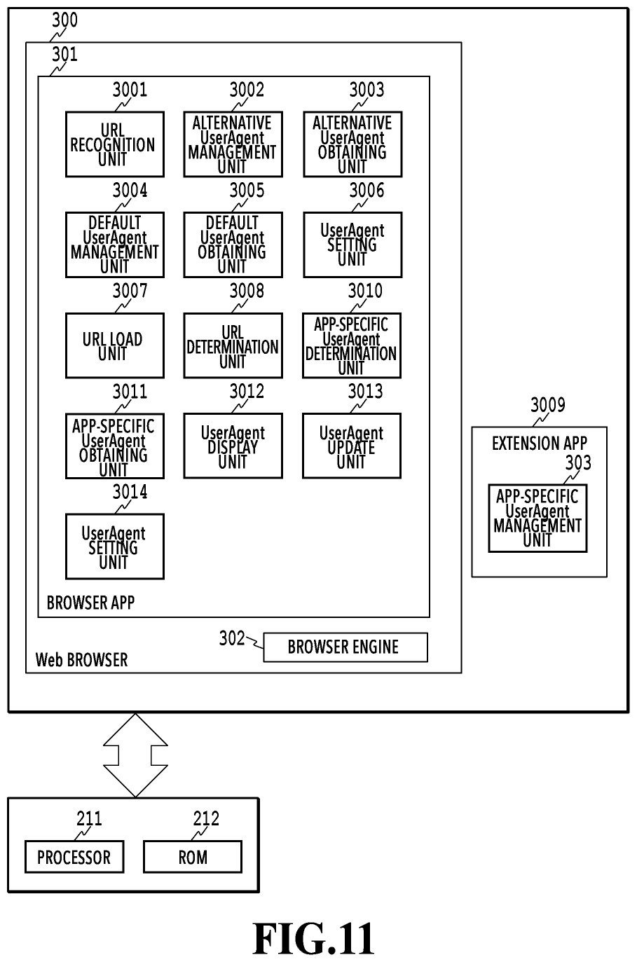

FIG. 11 is a functional block diagram showing a configuration of a Web browser 300 and an extension app 3009 according to the fourth embodiment.

Comparing FIGS. 7 and 11, only differences in configuration between the second and fourth embodiments will be described.

Compared to the browser app 301 of the second embodiment, a browser app 301 of the fourth embodiment additionally includes a UserAgent display unit 3012, a UserAgent update unit 3013, and a UserAgent setting unit 3014.

The UserAgent display unit 3012 displays one or more pairs of designated URLs and alternative UserAgents stored in the alternative UserAgent management table 401 in an editable table format on the display unit of the operation unit 219.

The UserAgent update unit 3013 receives an update to the alternative UserAgent by the user using the input function of the operation unit.

The UserAgent setting unit 3014 sets the updated alternative UserAgent in the alternative UserAgent management table 401.

### 3. Browser Operation

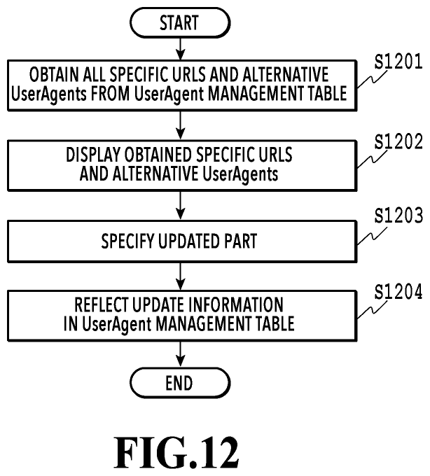

FIG. 12 is a flowchart showing a UserAgent update method according to the fourth embodiment.

In S1201, the alternative UserAgent obtaining unit 3003 obtains all pairs of designated URLs and alternative UserAgents stored in the alternative UserAgent management table 401 via the alternative UserAgent management unit 3002.

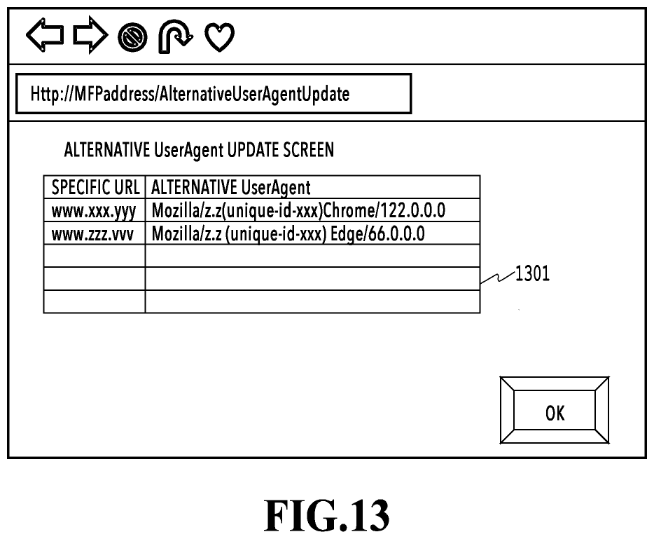

In S1202, the UserAgent display unit 3012 displays all the pairs of the designated URLs and the alternative UserAgents obtained by the alternative UserAgent obtaining unit 3003 on the display unit. A screen thus displayed is, for example, as shown in FIG. 13. In the screen shown in FIG. 13, all the pairs of the designated URLs and the alternative UserAgents obtained from the alternative UserAgent management table 401 are displayed in an editable manner in a table 1301.

In S1203, the UserAgent update unit 3013 receives an update to the alternative UserAgent by the user using the input function of the operation unit. As shown in FIG. 13, the alternative UserAgent corresponding to the specific URL “www.xxx.yyy”, for example, is thus updated as follows. That is, “Mozilla/z.z (unique-id-xxx) Chrome/66.0.0.0” is updated to “Mozilla/z.z (unique-id-xxx) Chrome/122.0.0.0”.

In S1204, the UserAgent setting unit 3014 sets the updated alternative UserAgent in the alternative UserAgent management table 401.

According to the fourth embodiment, for example, the user can update the alternative UserAgent in accordance with the update to the browser supported by the Web server 102.

Instead of displaying the screen shown in FIG. 13 on the display unit of the operation unit 219, the screen may be displayed on a screen of the PC 103 by modifying the UserAgent display unit 3012 and the UserAgent update unit 3013.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, a Web browser that is not supported by a Web server can display a normal screen based on Web content transmitted from the Web server.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-097519 filed Jun. 17, 2024, which is hereby incorporated by reference herein in its entirety.

1. An information processing apparatus comprising:
a first transmitting unit that transmits a request including an access destination URL for downloading Web content and a default UserAgent to a Web server designated by the access destination URL, in a case where the Web server designated by the access destination URL does not match a Web server designated by a registered URL; and
a second transmitting unit that transmits a request including the access destination URL and an alternative UserAgent associated with the registered URL to the Web server designated by the access destination URL, in a case where the Web server designated by the access destination URL matches the Web server designated by the registered URL.

2. The information processing apparatus according to claim 1, wherein
there are a plurality of the registered URLs,
in a case where the Web server designated by the access destination URL does not match any of the plurality of Web servers designated by the plurality of registered URLs, the first transmitting unit transmits a request including the access destination URL and a default UserAgent to the Web server designated by the access destination URL,
in a case where the Web server designated by the access destination URL matches any of the Web servers designated by the plurality of registered URLs, the second transmitting unit transmits a request including the access destination URL and the alternative UserAgent associated with the registered URL that matches the access destination URL to the Web server designated by the access destination URL.

3. The information processing apparatus according to claim 1, further comprising:
a third transmitting unit that transmits a request including the access destination URL and an app-specific UserAgent to the Web server designated by the access destination URL, in a case where there is an extension app holding the app-specific UserAgent to be included in the request, even in a case where the Web server designated by the access destination URL does not match the Web server designated by the registered URL.

4. The information processing apparatus according to claim 3, wherein
there are a plurality of the registered URLs,
in a case where there is the extension app holding the app-specific UserAgent to be included in the request, even in a case where the Web server designated by the access destination URL does not match any of the plurality of Web servers designated by the plurality of registered URLs, the third transmitting unit transmits a request including the access destination URL and the app-specific UserAgent to the Web server designated by the access destination URL.

5. An information processing apparatus comprising:
a first transmitting unit that transmits a request including an access destination URL for downloading Web content and a default UserAgent to a Web server designated by the access destination URL, in a case where there is no extension app that holds an app-specific UserAgent to be included in a request to be transmitted to the Web server designated by the access destination URL; and
a second transmitting unit that transmits a request including the access destination URL and the app-specific UserAgent to the Web server designated by the access destination URL, in a case where there is the extension app that holds the app-specific UserAgent.

6. The information processing apparatus according to claim 5, further comprising:
a third transmitting unit that transmits a request including the access destination URL and an alternative UserAgent associated with the registered URL to the Web server designated by the access destination URL, in a case where the Web server designated by the access destination URL matches the Web server designated by the registered URL even in a case wherein there is no extension app that holds the app-specific UserAgent.

7. The information processing apparatus according to claim 6, wherein
there are a plurality of the registered URLs, and
the third transmitting unit transmits a request including the access destination URL and an alternative UserAgent associated with the registered URL indicating the Web server designated by the access destination URL to the Web server designated by the access destination URL, in a case wherein the Web server designated by the access destination URL matches the Web server designated by any of the registered URLs even in a case where there is no extension app that holds the app-specific UserAgent.

8. The information processing apparatus according to claim 1, wherein
the default UserAgent includes information about a type of a Web browser used to display a screen based on the Web content.

9. The information processing apparatus according to claim 1, wherein
the alternative UserAgent includes information about a type of a Web browser other than a Web browser used to display a screen based on the Web content.

10. The information processing apparatus according to claim 1, wherein
the alternative UserAgent includes information about a type of any of Web browsers supported by the Web server designated by the registered URL.

11. The information processing apparatus according to claim 1, wherein
the alternative UserAgent includes information about a type of a Web browser that satisfies Conditions 1 to 3 below:
Condition 1: The type of Web browser is other than that of the Web browser used to display a screen based on the Web content.
Condition 2: The type of Web browser is any of the Web browsers supported by the Web server designated by the registered URL.
Condition 3: A normal screen can be displayed by the Web browser used to display a screen based on the Web content generated by the Web server designated by the registered URL so as to correspond to that type of Web browser.

12. The information processing apparatus according to claim 1, wherein
the registered URL and the alternative UserAgent are stored in a correspondence table in association with each other.

13. The information processing apparatus according to claim 12, further comprising:
a unit that updates the correspondence table.

14. The information processing apparatus according to claim 1, further comprising:
at least one of a printer unit that prints an image based on image data and a scanner unit that reads an image on a document to generate image data.

15. The information processing apparatus according to claim 5, further comprising:
at least one of a printer unit that prints an image based on image data and a scanner unit that reads an image on a document to generate image data.
